(19) United States
(12) Patent Application Publication
(10) Pub. No.: US 2017/0026984 A1
(43) Pub. Date: Jan. 26, 2017

(54) Downlink Scheduling Method and Device

(71) Applicant: Huawei Technologies Co., Ltd., Shenzhen (CN)

(72) Inventors: Yinke Shi, Hefei (CN); Libo Wang, Hefei (CN); Ling Qiu, Hefei (CN); Zongjie Wang, Shanghai (CN); Peng Zhang, Shanghai (CN)

(21) Appl. No.: 15/288,803

(22) Filed: Oct. 7, 2016

Related U.S. Application Data
(63) Continuation of application No. PCT/CN2014/075133, filed on Apr. 11, 2014.

(51) Int. Cl. H04W 72/12

(52) U.S. Cl. CPC H04W 72/12; H04W 72/1231; H04W 84/045

(57) ABSTRACT

An embodiment method includes obtaining information about a serving node and information about a coordinating node of an edge user, performing coordinated scheduling on the edge user according to the information about the serving node and the information about the coordinating node, determining whether the serving node and the coordinating node can simultaneously schedule the edge user. In response to a determination that the serving node and the coordinating node can simultaneously schedule the edge user, the method further includes instructing the serving node and the coordinating node to allocate a same code channel resource to send data to the edge user.

### CROSS-REFERENCE TO RELATED APPLICATIONS

This application is a continuation of International Application No. PCT/CN2014/075133, filed on Apr. 11, 2014, the disclosure of which is hereby incorporated by reference in its entirety.

### TECHNICAL FIELD

The present disclosure relates to the communications field, and in particular embodiments, to a downlink scheduling method and device.

### BACKGROUND

In a conventional cellular softcell, which is also referred to as a homogeneous network, a macrocell needs to cover a large area. Because of impact such as a path loss and small-scale fading of a radio channel, performance of a cell-edge user cannot be ensured, a user access distance is relatively long, and energy consumption of a user terminal is relatively large. To further improve performance of a cellular softcell system, a concept of a heterogeneous network is generated, and a main idea of the concept is to improve a system capacity by means of cell splitting and improve energy efficiency by reducing an access distance. The heterogeneous network is generated based on the homogeneous network, and a specific network deployment manner is that several Low Power Node (LPN) are deployed according to a rule within an area covered by a macrocell in the homogeneous network, and an area covered by these LPNs is referred to as a picocell.

In the heterogeneous network, the Macrocell and the Picocell generally use co-channel deployment. Although this co-channel deployment structure can improve an overall cell capacity, the structure causes a lot of problems, for example, a frequent handover problem and an inter-cell interference problem that are caused by decrease of cell coverage.

To resolve the foregoing problems, a combined cell deployment scenario is available, and this deployment scenario is also referred to as a softcell. The softcell is the same as the co-channel deployment scenario, that is, multiple LPNs are also deployed in the Macrocell, and a difference is that the Picocell covered by the LPNs has a same cell ID as that of the Macrocell. As shown in FIG. 1, FIG. 1 is a system architecture diagram of a softcell according to the prior aft. It is assumed that, N(=2) Low Power Node (LPN) are deployed in a Macrocell, a macrocell (Base Station) is referred to as a transmission node T₀, an coverage area is referred to as S₀, an LPN is referred to as a transmission node Tᵢ (i=1, . . . , N), and an area covered by Tᵢ is referred to as Sᵢ. According to a definition of the softcell, Sᵢ has a same cell ID as that of S₀. It can be seen from description about the softcell that, because the Macrocell and the Picocell that are in the softcell use a same cell ID, a user does not need to perform frequent handover in a movement process in the softcell, and only needs to select a suitable transmission node for access.

For a High Speed Downlink Packet Access (HSDPA) heterogeneous network, when the co-channel deployment scenario is used, decrease of cell coverage increases a user handover frequency, causing severe problems such as call drop of the user, and video interrupt. Although using the softcell deployment scenario described above may avoid handover in the softcell, because the transmission nodes in the softcell use a same scrambling code, a cell-edge user suffers from severe co-code-channel interference, severely reducing performance of the edge user.

To improve quality of a signal received by the user, the macrocell and the LPN may perform data transmission in Single Frequency Network (SFN) transmission mode. In the softcell, the LPN and the BS are connected to a CCU through a fiber link, and the CCU centrally controls data transmission between the LPN and the BS. That is, all the transmission nodes simultaneously serve a user in a same code channel resource, and the user is not only an edge user, but also refers to a non-edge user. Although the SFN transmission mode can effectively improve performance of the edge user, because the LPN and the BS need to simultaneously serve a user on a same code channel, waste of a code channel resource is relatively severe. It can be seen from above that an SFN transmission solution is a method for improving performance of an edge user at the cost of sacrificing an overall throughput, and this solution goes counter to an original intention of putting forward a heterogeneous network technology.

To improve a throughput of the softcell, the user in the coverage of the transmission nodes needs to perform code channel multiplexing, and then transmit data according to Spatial Reuse Mode (SRM). In an SRM transmission mode solution, a Central Control Unit (CCU) independently schedules a user served by a transmission node T₀ and a transmission node T₁, and in a scheduling process, interference that may be caused to the edge user by a scheduling result in the coverage of the transmission node T₁ is not considered. Therefore, the edge user suffers from huge interference from the transmission node T₁, and particularly in the softcell, because a same scrambling code is used between the transmission nodes, and this type of co-channel interference is particularly huge, a CQI of an edge user is reduced, and a communication rate is also reduced accordingly. Although the SRM solution may use a remaining resource of another transmission node to serve the edge user, for a hotspot distribution scenario, this type of solution not only fails to improve performance of the edge user, but also increases complexity of protocol implementation. Therefore, how to improve performance of an edge user while improving code channel resource utilization is a problem to be resolved.

### SUMMARY

Embodiments of the present disclosure provide a downlink scheduling method and device, to resolve a problem about how to improve performance of an edge user when an average throughput rate comparable with that of an SRM solution is obtained.

According to a first aspect, a downlink scheduling method is provided, where the method includes the following. Obtaining, by a macrocell, information about a serving node and information about a coordinating node of an edge user, where the serving node refers to a node whose strength of reference signal power, received by the edge user from all nodes in a softcell in which the edge user is located, is first strength, the coordinating node refers to a node whose strength of reference signal power, received by the edge user from all the nodes in the softcell in which the edge user is located, is second strength, and the edge user refers to a user with a difference between the first strength and the second strength of the reference signal power being within a preset threshold. Performing, by the macrocell, coordinated scheduling on the edge user according to the information about the serving node and the information about the coordinating node; and determining, by the macrocell, whether the serving node and the coordinating node can simultaneously schedule the edge user. In response to a determination that the serving node and the coordinating node can simultaneously schedule the edge user, the method further includes instructing, by the macrocell, the serving node and the coordinating node to allocate a same code channel resource to send data to the edge user.

With reference to the first aspect, in a first possible implementation manner of the first aspect, the determining, by the macrocell, whether the serving node and the coordinating node can simultaneously schedule the edge user includes the following. Simultaneously receiving, by the edge user in a current subframe, coordinated scheduling of the serving node and the coordinating node, and calculating, according to a signal to interference plus noise ratio CQI_edge3 of the coordinated scheduling, a PF priority corresponding to the edge user served by the serving node and a proportional fairness PF priority corresponding to the edge user served by the coordinating node. Comparing the PF priority corresponding to the edge user served by the serving node and the PF priority corresponding to the edge user served by the coordinating node with PF priorities corresponding to another user separately served by the serving node and the coordinating node. If the PF priority corresponding to the edge user served by the serving node is higher than a PF priority corresponding to the another user served by the serving node, the serving node can schedule the edge user; and if the PF priority corresponding to the edge user served by the coordinating node is higher than a PF priority corresponding to the another user served by the coordinating node, the coordinating node can schedule the edge user.

With reference to the first aspect or the first possible implementation manner of the first aspect, in a second possible implementation manner of the first aspect, the method further includes: if the serving node and the coordinating node cannot simultaneously schedule the edge user, determining whether the serving node can schedule the edge user. In response to a determination that the serving node can schedule the edge user, the serving node independently schedules the edge user. The determining whether the serving node can schedule the edge user includes: calculating, according to a signal to interference plus noise ratio CQI_edge1 of the independent scheduling of the serving node, a PF priority corresponding to the edge user served by the serving node in a case in which the edge user receives independent scheduling of the serving node; and comparing the PF priority corresponding to the edge user served by the serving node with a PF priority corresponding to another user served by the serving node, where if the PF priority corresponding to the edge user served by the serving node is higher than the PF priority corresponding to the another user served by the serving node, the serving node can independently schedule the edge user.

With reference to the second possible implementation manner of the first aspect, in a third possible implementation manner of the first aspect, the method further includes if the serving node and the coordinating node cannot simultaneously schedule the edge user, and the serving node cannot schedule the edge user, determining whether the coordinating node can schedule the edge user. In response to a determination that the coordinating node can schedule the edge user, the coordinating node independently schedules the edge user. The determining whether the coordinating node can schedule the edge user includes: in a case in which the edge user receives independent scheduling of the coordinating node, calculating, according to a signal to interference plus noise ratio CQI_edge2 of the independent scheduling of the coordinating node, a PF priority corresponding to the edge user served by the coordinating node; and comparing the PF priority corresponding to the edge user served by the coordinating node with a PF priority corresponding to another user served by the coordinating node. If the PF priority corresponding to the edge user served by the coordinating node is higher than the PF priority corresponding to the another user served by the coordinating node, the coordinating node can independently schedule the edge user.

With reference to the third possible implementation manner of the first aspect, in a fourth possible implementation manner of the first aspect, the method further includes receiving, by the macrocell, CQI information fed back by the edge user by using a differential feedback method, where the differential feedback manner is: feeding back CQI_edge1, a difference between CQI_edge2 and CQI_edge1, and a difference between CQI_edge3 and CQI_edge1, or presetting thresholds X and Y, if CQI_edge2 is higher than CQI_edge1 by X or more than X, feeding back X, and if CQI_edge3 is higher than CQI_edge1 by Y or more than Y, feeding back Y.

With reference to the first aspect, the first possible implementation manner of the first aspect, the second possible implementation manner of the first aspect, the third possible implementation manner of the first aspect or the fourth possible implementation manner of the first aspect, in a fifth possible implementation manner of the first aspect, the method further includes: if the serving node and the coordinating node cannot simultaneously schedule the edge user, the serving node cannot independently schedule the edge user, and the coordinating node cannot independently schedule the edge user, skipping, by the macrocell, scheduling the edge user.

With reference to the first aspect, the first possible implementation manner of the first aspect, the second possible implementation manner of the first aspect, the third possible implementation manner of the first aspect, the fourth possible implementation manner of the first aspect, or the fifth possible implementation manner of the first aspect, in a sixth possible implementation manner of the first aspect, the method further includes scheduling a center user according to spatial reuse mode SRM, where the center user refers to a user with a difference between the first strength and the second strength of the reference signal power being greater than the preset threshold.

According to a second aspect, a downlink scheduling device is provided, where the device includes the following. An obtaining unit, configured to obtain information about a serving node and information about a coordinating node of an edge user, where the serving node refers to a node whose strength of reference signal power, received by the edge user from all nodes in a softcell in which the edge user is located, is first strength, the coordinating node refers to a node whose strength of reference signal power, received by the edge user from all the nodes in the softcell in which the edge user is located, is second strength, and the edge user refers to a user with a difference between the first strength and the second strength of the reference signal power being within a preset threshold. A coordinated scheduling unit, configured to perform coordinated scheduling on the edge user according to the information about the serving node and the information about the coordinating node. A determining unit, configured to determine whether the serving node and the coordinating node can simultaneously schedule the edge user. A notification unit, configured to instruct the serving node and the coordinating node to allocate a same code channel resource to send data to the edge user in response to a determination that the serving node and the coordinating node can simultaneously schedule the edge user.

With reference to the second aspect, in a first possible implementation manner of the second aspect, the determining unit is configured to simultaneously receive, by the edge user in a current subframe, coordinated scheduling of the serving node and the coordinating node, and calculate, according to a signal to interference plus noise ratio CQI_edge3 of the coordinated scheduling, a proportional fairness PF priority corresponding to the edge user served by the serving node and a PF priority corresponding to the edge user served by the coordinating node; and compare the PF priority corresponding to the edge user served by the serving node and the PF priority corresponding to the edge user served by the coordinating node with PF priorities corresponding to another user separately served by the serving node and the coordinating node. If the PF priority corresponding to the edge user served by the serving node is higher than a PF priority corresponding to the another user served by the serving node, the serving node can schedule the edge user; and if the PF priority corresponding to the edge user served by the coordinating node is higher than a PF priority corresponding to the another user served by the coordinating node, the coordinating node can schedule the edge user.

With reference to the second aspect or the first possible implementation manner of the second aspect, in a second possible implementation manner of the second aspect, the determining unit is further configured to if the serving node and the coordinating node cannot simultaneously schedule the edge user, determine whether the serving node can schedule the edge user. In response to a determination that the serving node can schedule the edge user, the serving node independently schedules the edge user. The determining whether the serving node can schedule the edge user includes in a case in which the edge user receives independent scheduling of the serving node, calculating, according to a signal to interference plus noise ratio CQI_edge1 of the independent scheduling of the serving node, a PF priority corresponding to the edge user served by the serving node; and comparing the PF priority corresponding to the edge user served by the serving node with a PF priority corresponding to another user served by the serving node. If the PF priority corresponding to the edge user served by the serving node is higher than the PF priority corresponding to the another user served by the serving node, the serving node can independently schedule the edge user.

With reference to the second possible implementation manner of the second aspect, in a third possible implementation manner of the second aspect, the determining unit is further configured to determine whether the coordinating node can schedule the edge user, if the serving node and the coordinating node cannot simultaneously schedule the edge user, and the serving node cannot schedule the edge user. In response to a determination that the coordinating node can schedule the edge user, the coordinating node independently schedules the edge user. The determining whether the coordinating node can schedule the edge user includes: in a case in which the edge user receives independent scheduling of the coordinating node, calculating, according to a signal to interference plus noise ratio CQI_edge2 of the independent scheduling of the coordinating node, a PF priority corresponding to the edge user served by the coordinating node; and comparing the PF priority corresponding to the edge user served by the coordinating node with a PF priority corresponding to another user served by the coordinating node. If the PF priority corresponding to the edge user served by the coordinating node is higher than the PF priority corresponding to the another user served by the coordinating node, the coordinating node can independently schedule the edge user.

With reference to the third possible implementation manner of the second aspect, in a fourth possible implementation manner of the second aspect, the device further includes a receiving unit, and the receiving unit is configured to: receive CQI information fed back by the edge user by using a differential feedback method, where the differential feedback manner is: feeding back CQI_edge1, a difference between CQI_edge2 and CQI_edge1, and a difference between CQI_edge3 and CQI_edge1, or presetting thresholds X and Y, if CQI_edge2 is higher than CQI_edge1 by X or more than X, feeding back X, and if CQI_edge3 is higher than CQI_edge1 by Y or more than Y, feeding back Y.

With reference to the second aspect, the first possible implementation manner of the second aspect, the second possible implementation manner of the second aspect, the third possible implementation manner of the second aspect or the fourth possible implementation manner of the second aspect, in a fifth possible implementation manner of the second aspect, the device further includes a processing unit, and the processing unit is configured to skip scheduling the edge user if the serving node and the coordinating node cannot simultaneously schedule the edge user, the serving node cannot independently schedule the edge user, and the coordinating node cannot independently schedule the edge user.

With reference to the second aspect, the first possible implementation manner of the second aspect, the second possible implementation manner of the second aspect, the third possible implementation manner of the second aspect, the fourth possible implementation manner of the second aspect or the fifth possible implementation manner of the second aspect, in a sixth possible implementation manner of the second aspect, the device further includes a scheduling unit, and the scheduling unit is configured to: schedule a center user according to spatial reuse mode SRM, where the center user refers to a user with a difference between the first strength and the second strength of the reference signal power being greater than the preset threshold.

In the present disclosure, information about a serving node and information about a coordinating node of an edge user are obtained, coordinated scheduling is performed on the edge user according to the information about the serving node and the information about the coordinating node, it is determined whether the serving node and the coordinating node can simultaneously schedule the edge user, and if yes, the serving node and the coordinating node are instructed to allocate a same code channel resource to send data to the edge user, so that the edge user is served in a coordinated transmission manner via beamforming based on code channel multiplexing, improving a received signal-to-noise ratio of the edge user.

### BRIEF DESCRIPTION OF THE DRAWINGS

To describe the technical solutions in the embodiments or in the prior art more clearly, the following briefly describes the accompanying drawings required for describing the embodiments or the prior art. Apparently, the accompanying drawings in the following description show merely some embodiments, and a person of ordinary skill in the art may still derive other drawings from these accompanying drawings without creative efforts.

FIG. 1 is a system architecture diagram of a softcell according to the prior art;

FIG. 2 is a flowchart of a downlink scheduling method according to an embodiment;

FIG. 3 is a system structural diagram of a downlink scheduling system according to an embodiment;

FIG. 4 is a line graph of a cumulative distribution function CDF of delta1CQI and delta2CQI according to an embodiment;

FIG. 5 is a schematic diagram of a downlink scheduling method according to an embodiment;

FIG. 6 is a structural diagram of a downlink scheduling device according to an embodiment; and

FIG. 7 is a structural diagram of another downlink scheduling device according to an embodiment.

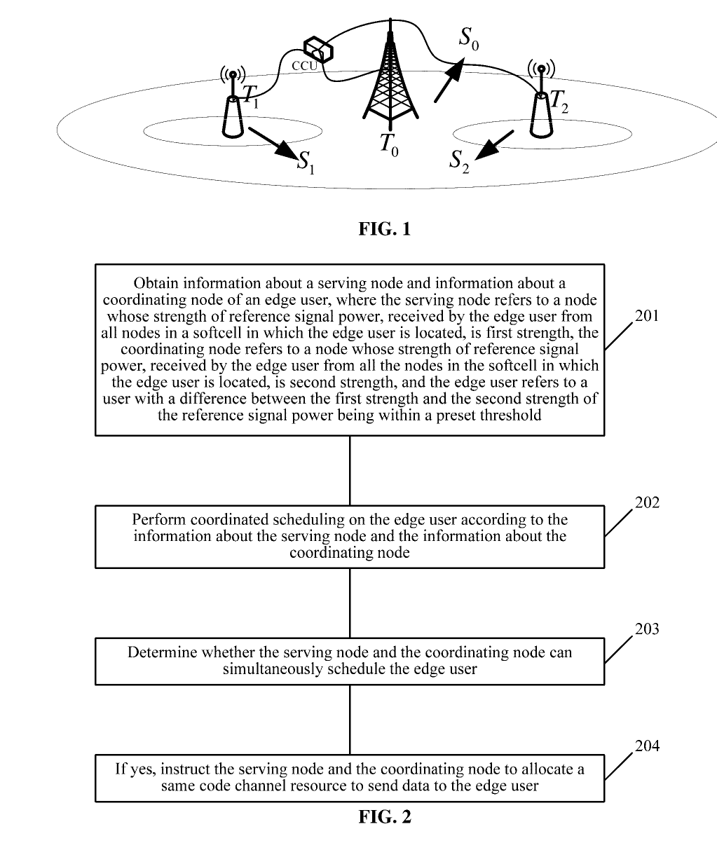

### DETAILED DESCRIPTION OF ILLUSTRATIVE EMBODIMENTS

The following clearly describes the technical solutions in the embodiments with reference to the accompanying drawings in the embodiments. Apparently, the described embodiments are merely some but not all of the embodiments. All other embodiments obtained by a person of ordinary skill in the art based on the embodiments without creative efforts shall fall within the protection scope of the present disclosure.

Referring to FIG. 2, FIG. 2 is a flowchart of a downlink scheduling method according to an embodiment. As shown in FIG. 2, the method includes the following steps.

Step 201: Obtain information about a serving node and information about a coordinating node of an edge user, where the serving node refers to a node whose strength of reference signal power, received by the edge user from all nodes in a softcell in which the edge user is located, is first strength, the coordinating node refers to a node whose strength of reference signal power, received by the edge user from all the nodes in the softcell in which the edge user is located, is second strength, and the edge user refers to a user with a difference between the first strength and the second strength of the reference signal power being within a preset threshold.

The serving node refers to the node whose strength of reference signal power, received by the edge user from all the nodes in the softcell in which the edge user is located, is the first strength, the coordinating node refers to the node whose strength of reference signal power, received by the edge user from all the nodes in the softcell in which the edge user is located, is the second strength, the information about the serving node includes but is not limited to an Identity (ID) of the serving node, and the information about the coordinating node includes but is not limited to an ID of the coordinating node.

A definition of a softcell edge user is as follows.

When a difference between a strength of a signal sent from a serving node of a user to the user and a strength of a signal sent from a transmission node, which causes maximum interference to the user, to the user is less than n dB, and when the transmission node that causes maximum interference to the user and the serving node of the user are in a same softcell, the user is referred to as a softcell edge user, and the transmission node that causes maximum interference to the user is marked as a coordinating node of the user.

A definition of a softcell center user is as follows.

If a user does not meet the definition of the softcell edge user, the user is a softcell center user.

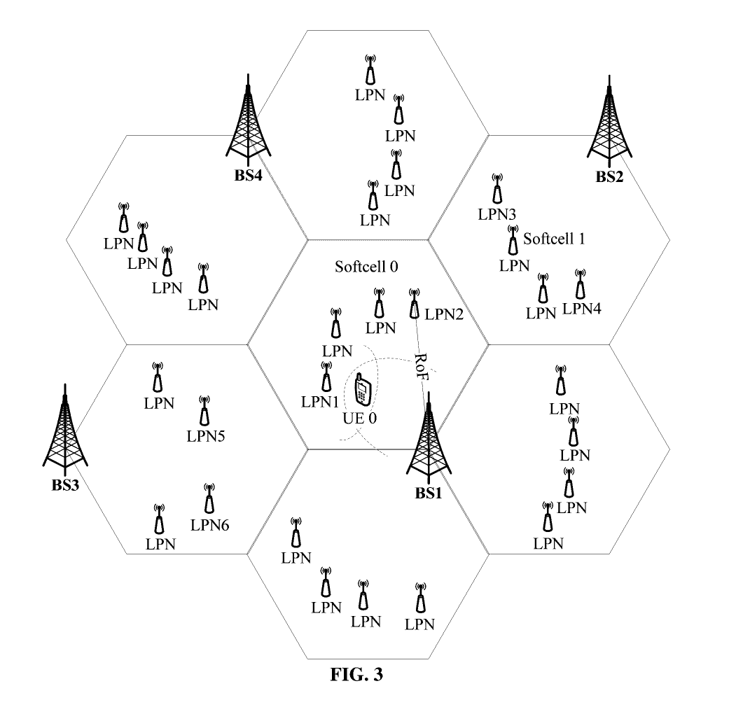

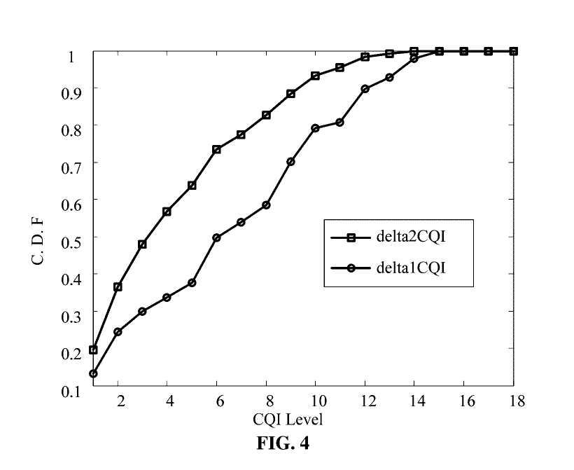

Specifically, referring to FIG. 3, FIG. 3 is a structural diagram of a downlink scheduling system according to an embodiment. As shown in FIG. 3, a UMTS cellular system having 7 sites and 21 cells is used in this embodiment. FIG. 3 only shows a schematic diagram of seven cells, and other cells are generated in a wrap-around manner. Each hexagonal cell in the figure represents a softcell, four LPNs are placed in each softcell, and the LPNs use an edge-fixed distribution scenario shown in FIG. 3, where an ISD represents a distance between two closest BSs. There are sixteen users in each softcell, and the users use a hotspot distribution scenario, that is, 75% of the users are distributed within coverage of the LPNs. Two antennas are configured for each of an LPN, a user, and a base station (corresponding to a sector). A Softcell o is used as an example in this embodiment, to describe a coordinated transmission solution of joint beamforming in the present disclosure. First, each user determines a serving node of the user according to a long-time sounding signal broadcasted by a transmission node in the softcell, and determines whether the user belongs to an edge user or a center user. A specific determining criterion is: when a difference between strength of a signal received by a user from a serving node and strength of a signal received by the user from a transmission node having maximum interference is less than 6 dB, and the transmission node that causes maximum interference to the user and the serving node of the user are in a same softcell, the user is an edge user, and the transmission node that causes maximum interference to the user is marked as a coordinating node of the user. If the user does not meet the foregoing determining criterion, the user is a center user.

Preferentially, the method further includes receiving Channel Quality Indicator (CQI) information fed back by the edge user by using a differential feedback method, where the differential feedback manner is: feeding back CQI_edge1, a difference between CQI_edge2 and CQI_edge1, and a difference between CQI_edge3 and CQI_edge1, or presetting thresholds X and Y, if CQI_edge2 is higher than CQI_edge1 by X or more than X, feeding back X, and if CQI_edge3 is higher than CQI_edge1 by Y or more than Y, feeding back Y.

Specifically, for the softcell center user, after obtaining a channel H from the user to the serving node by means of channel estimation, the softcell center user first selects a codebook that can maximize a received signal power of the user from a precoding codebook set C={w₁, w₂, w₃, w₄} listed in Table 1 as a precoding vector of the user, and marks the precoding vector as a Precoding Control Indicator (PCI):

$${PCI}_{c} = {arg max}_{w ∈ C} ( {‖ H \cdot ( {I}_{L} ⊗ {w}^{H} ) ‖}^{2} ) ,$$

and solves a CQI: CQI_{c} corresponding to an optimal PCI, where I_{L} is an identity matrix of L×L, L is a quantity of multipaths, \textcircled{×} is a Kronecker product, ∥V∥² is a second order norm of a matrix/vector v, and w^{H} is a conjugate transpose of w. The center user uses 2 bits to feed back PCI_{c}, and 5 bits to feed back CQI_{c} to a CCU.

TABLE 1

| w₁ | w₂ | w₃ | w₄ |
|---|---|---|---|
| $[ \frac{1}{\sqrt{2}} \frac{1 + j}{2} ]$ | $[ \frac{1}{\sqrt{2}} \frac{1 - j}{2} ]$ | $[ \frac{1}{\sqrt{2}} \frac{- 1 + j}{2} ]$ | $[ \frac{1}{\sqrt{2}} \frac{- 1 - j}{2} ]$ |

For the softcell edge user, three groups of {PCI, CQI} need to be fed back. The edge user first obtains channels H₁ and H₂ from the edge user to the serving node and the coordinating node by means of channel estimation; then separately obtains, according to a criterion of maximizing a received signal power, a

$$PCI \text{:} {PCI}_{1} = {arg max}_{w ∈ C} ( {‖ {H}_{1} \cdot ( {I}_{L} ⊗ {w}^{H} ) ‖}^{2} )$$

independently served by the serving node, a PCI:

$${PCI}_{2} = {arg max}_{w ∈ C} ( {‖ {H}_{2} \cdot ( {I}_{L} ⊗ {w}^{H} ) ‖}^{2} )$$

independently served by the coordinating node, and PCIs:

$$\{ {PCI}_{3} , {PCI}_{4} \} = {arg max}_{w ∈ C} ( {‖ {H}_{1} \cdot ( {I}_{L} ⊗ {w}^{H} ) ‖}^{2} + {‖ {H}_{2} \cdot ( {I}_{L} ⊗ {w}^{H} ) ‖}^{2} )$$

when the serving node and the coordinating node perform coordinated transmission by means of beamforming; and separately solves, according to an optimal PCI, a CQI: CQI₁ independently served by the serving node, a CQI: CQI₂ independently served by the coordinating node, and a CQI: CQI₃ during coordinated transmission of the serving node and the coordinating node. deltaCQI₁=CQI₁−CQI₂, deltaCQI₂=CQI₃−CQI₁, and the edge user feeds back full information of PCI₁, PCI₂, PCI₃, PCI₄, and CQI₁, and feeds back CQI₂ and CQI₃ in the differential feedback manner.

Recalling that delta1CQI=CQI₁−CQI₂ and delta2CQI=CQI₃−CQI₁. Referring to FIG. 4, FIG. 4 is a line graph of a Cumulative Distribution Function (CDF) of delta1CQI and delta2CQI according to an embodiment. It can be seen from the line graph that, values of both delta1CQI and delta2CQI are basically less than 14, so that 3 bits are used to feed back delta1CQI and delta2CQI in this embodiment. A specific differential feedback policy of an edge user is given below: the edge user uses 7 bits to feed back full information of {PCI₁, CQI₁}, uses 5 bits to feed back {PCI₂, delta1CQI}, and uses 7 bits to feed back {PCI₃, PCI₄, delta2CQI}. The edge user can obtain CQI₂ and CQI₃ according to CQI₁, delta1CQI, and delta2CQI. This differential feedback manner can reduce a feedback amount by 4 bits compared with a full-information feedback manner, and a subsequent emulation result shows that performance gains that are obtained by the differential feedback manner and the full-information feedback manner are equal.

Step 202: Perform coordinated scheduling on the edge user according to the information about the serving node and the information about the coordinating node.

Step 203: Determine whether the serving node and the coordinating node can simultaneously schedule the edge user.

Optionally, the determining whether the serving node and the coordinating node can simultaneously schedule the edge user includes simultaneously receiving, by the edge user in a current subframe, coordinated scheduling of the serving node and the coordinating node, and calculating, according to a signal to interference plus noise ratio CQI_edge3 of the coordinated scheduling, a Proportional Fairness (PF) priority corresponding to the edge user served by the serving node and a PF priority corresponding to the edge user served by the coordinating node; and comparing the PF priority corresponding to the edge user served by the serving node and the PF priority corresponding to the edge user served by the coordinating node with PF priorities corresponding to another user separately served by the serving node and the coordinating node. If the PF priority corresponding to the edge user served by the serving node is higher than a PF priority corresponding to the another user served by the serving node, the serving node can schedule the edge user; and if the PF priority corresponding to the edge user served by the coordinating node is higher than a PF priority corresponding to the another user served by the coordinating node, the coordinating node can schedule the edge user.

Step 204: If it is determined that the serving node and the coordinating node can simultaneously schedule the edge user, instruct the serving node and the coordinating node to allocate a same code channel resource to send data to the edge user.

Optionally, the method further includes determining whether the serving node can schedule the edge user, if the serving node and the coordinating node cannot simultaneously schedule the edge user. In response to a determination that the serving node can schedule the edge user, the serving node independently schedules the edge user. The determining whether the serving node can schedule the edge user includes: in a case in which the edge user receives independent scheduling of the serving node, calculating, according to a signal to interference plus noise ratio CQI_edge1 of the independent scheduling of the serving node, the PF priority corresponding to the edge user served by the serving node; and comparing the PF priority corresponding to the edge user served by the serving node with a PF priority corresponding to another user served by the serving node. If the PF priority corresponding to the edge user served by the serving node is higher than the PF priority corresponding to the another user served by the serving node, the serving node can independently schedule the edge user.

Optionally, the method further includes: if the serving node and the coordinating node cannot simultaneously schedule the edge user, and the serving node cannot schedule the edge user, determining whether the coordinating node can schedule the edge user. In response to a determination that the coordinating node can schedule the edge user, the coordinating node independently schedules the edge user. The determining whether the coordinating node can schedule the edge user includes: in a case in which the edge user receives independent scheduling of the coordinating node, calculating, according to a signal to interference plus noise ratio CQI_edge2 of the independent scheduling of the coordinating node, the PF priority corresponding to the edge user served by the coordinating node; and comparing the PF priority corresponding to the edge user served by the coordinating node with a PF priority corresponding to another user served by the coordinating node. If the PF priority corresponding to the edge user served by the coordinating node is higher than the PF priority corresponding to the another user served by the coordinating node, the coordinating node can independently schedule the edge user.

Optionally, the method further includes: if the serving node and the coordinating node cannot simultaneously schedule the edge user, the serving node cannot independently schedule the edge user, and the coordinating node cannot independently schedule the edge user, skipping scheduling the edge user.

Optionally, the method further includes: scheduling a center user according to Spatial Reuse Mode (SRM), where the center user refers to a user with a difference between the first strength and the second strength of the reference signal power being greater than the preset threshold.

Specifically, a CCU first performs grouping according to sequence number information of the serving node and the coordinating node fed back by users. In this embodiment, there are five transmission nodes in a softcell, so that the users are divided into five groups, each transmission node is responsible for data transmission of the node used as a serving node, and the CCU independently performs PF scheduling on users of each group. A user group in which a BS is a serving node is used as an example below to describe a coordinated scheduling solution put forward in the present disclosure, and a process of scheduling a user served by another transmission node is the same. It is assumed that there are p center users and q edge users in the group, and a coordinating node set assisting in transmission of the edge users of the group is C. A CQI set fed back by the center users is {CQI_{c}}, a CQI set that is fed back by the edge user and that is independently served by the serving node is {CQI₁}, a CQI set that is fed back by the edge user and that is independently served by the coordinating node is {CQI₂}, and a CQI set fed back by the edge user when the serving node and the coordinating node perform coordinated transmission by means of beamforming is {CQI₃}.

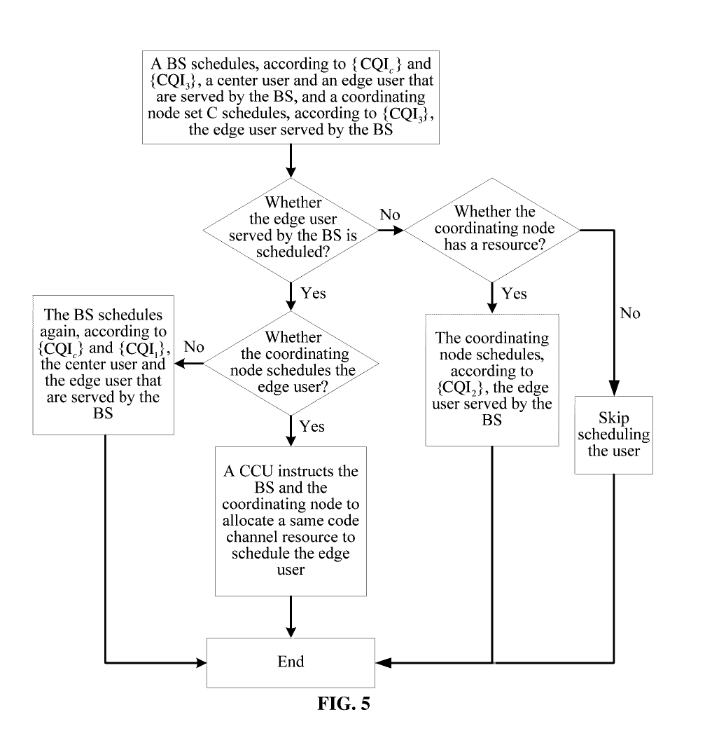

Referring to FIG. 5, FIG. 5 is a schematic diagram of a downlink scheduling method according to an embodiment. As shown in FIG. 5, a BS schedules a center user and an edge user that belong to a BS group according to {CQI_{c}} and {CQI₃}, and instructs a coordinating node set C to schedule the edge user that belongs to the BS group according to {CQI₃}. If the BS and a coordinating node simultaneously schedule a same edge user, a CCU instructs the BS and the coordinating node to allocate a same code channel resource to schedule the edge user. If the BS schedules an edge user, but the coordinating node does not schedule the same edge user, the BS schedules again the center user and the edge user that belong to the BS group according to {CQI_{c}} and {CQI₁}, and if the BS schedules the edge user, the BS allocates a corresponding resource to schedule the edge user. If neither the BS nor the coordinating node schedules an edge user, the CCU queries whether the coordinating node has a remaining resource, and if there is a remaining resource, the coordinating node schedules the edge user according to {CQI₂}, and then the coordinating node allocates a corresponding resource to the edge user to perform data transmission. If neither the BS nor the coordinating node schedules an edge user, and the coordinating node does not have a remaining resource, no edge user is scheduled.

In the present disclosure, a coordinated scheduling solution of joint beamforming is put forward mainly for a problem of spectrum resource waste in SFN transmission mode and a problem of relatively poor performance of an edge user in SRM transmission mode that exist in a softcell.

The solution serves an edge user in a coordinated transmission manner via beamforming based on code channel multiplexing, improving a received signal-to-noise ratio of the edge user. During feedback, a center user needs to feed back a CQI independently served by a serving node, and the edge user needs to feed back the CQI independently served by the serving node, a CQI independently served by a coordinating node, and a CQI when the serving node and the coordinating node perform coordinated transmission by means of beamforming. During scheduling, the center user always does not perform coordinated transmission, only the edge user may perform coordinated transmission, and the center user performs scheduling according to a PF algorithm. For the edge user, the serving node performs scheduling according to the CQI of the coordinated transmission, and the coordinating node needs to use the edge user of the serving node as a user of the coordinating node, and likewise schedules the edge user served by the serving node according to the CQI of the coordinated transmission. Only when the serving node and the coordinating node simultaneously schedule a same edge user, the CCU instructs the serving node and the coordinating node to perform coordinated transmission by means of beamforming. If the serving node schedules the edge user, the coordinating node does not schedule the edge user, the serving node performs second-level scheduling on the edge user according to the CQI independently served by the serving node, and if the serving node schedules the edge user, the CCU allocates a resource to the serving node to perform data transmission. If neither the serving node nor the coordinating node schedules the edge user, but the coordinating node has a remaining code channel resource, the coordinating node schedules the edge user according to the CQI independently served by the coordinating node.

A cell throughput rate, a cell throughput rate of 50% users, and a cell throughput rate of worst 5% users of an SRM scheduling solution, a coordinated scheduling solution in a full-information feedback manner in the present disclosure, and a coordinated scheduling solution in a differential feedback manner in the present disclosure are given below. The SRM scheduling solution uses a method for independently performing PF scheduling between the transmission nodes.

TABLE 2

| | Throughput | Throughput | Average |
|---|---|---|---|
| | rate of | rate of | throughput |
| | worst 5% users | 50% users | rate of users |
| SRM solution | 100% | 100% | 100% |
| Full-information | 145.3% | 119.04% | 107.82% |
| feedback coordinated | | | |
| scheduling solution | | | |
| Differential feedback | 139.23% | 112.37% | 103.43% |
| coordinated | | | |
| scheduling solution | | | |

It can be seen from Table 2 that, the coordinated scheduling solution of joint beamforming put forward in the present disclosure has better performance than that of the existing SRM solution in terms of an average throughput rate, a throughput rate of 50% users, and a throughput rate of worst 5% users, and particularly greatly improves performance of an edge user. Compared with the full-information feedback coordinated scheduling solution, the differential feedback coordinated scheduling solution has a performance loss, but the performance loss is not so large, and particularly in terms of performance of an edge user, the differential feedback coordinated scheduling solution still has a performance gain of 39.23% compared with the SRM solution.

In the present disclosure, information about a serving node and information about a coordinating node of an edge user are obtained, coordinated scheduling is performed on the edge user according to the information about the serving node and the information about the coordinating node, it is determined whether the serving node and the coordinating node can simultaneously schedule the edge user, and if yes, the serving node and the coordinating node are instructed to allocate a same code channel resource to send data to the edge user, so that the edge user is served in a coordinated transmission manner via beamforming based on code channel multiplexing, improving a received signal-to-noise ratio of the edge user.

Referring to FIG. 6, FIG. 6 is a structural diagram of a downlink scheduling device according to an embodiment. As shown in FIG. 6, the device includes:

An obtaining unit 601, configured to obtain information about a serving node and information about a coordinating node of an edge user, where the serving node refers to a node whose strength of reference signal power, received by the edge user from all nodes in a softcell in which the edge user is located, is first strength, the coordinating node refers to a node whose strength of reference signal power, received by the edge user from all the nodes in the softcell in which the edge user is located, is second strength, and the edge user refers to a user with a difference between the first strength and the second strength of the reference signal power being within a preset threshold.

A definition of a softcell edge user is as follows.

When a difference between a strength of a signal sent from a serving node of a user to the user and a strength of a signal sent from a transmission node, which causes maximum interference to the user, to the user is less than n dB, and when the transmission node that causes maximum interference to the user and the serving node of the user are in a same softcell, the user is referred to as a softcell edge user, and the transmission node that causes maximum interference to the user is marked as a coordinating node of the user.

A definition of a softcell center user is as follows.

If a user does not meet the definition of the softcell edge user, the user is a softcell center user.

Preferentially, the device further includes a receiving unit, and the receiving unit is configured to receive CQI information fed back by the edge user by using a differential feedback method, where the differential feedback manner is: feeding back CQI_edge1, a difference between CQI_edge2 and CQI_edge1, and a difference between CQI_edge3 and CQI_edge1, or presetting thresholds X and Y, if CQI_edge2 is higher than CQI_edge1 by X or more than X, feeding back X, and if CQI_edge3 is higher than CQI_edge1 by Y or more than Y, feeding back Y.

A coordinated scheduling unit 602, configured to perform coordinated scheduling on the edge user according to the information about the serving node and the information about the coordinating node.

A determining unit 603, configured to determine whether the serving node and the coordinating node can simultaneously schedule the edge user.

Optionally, the determining unit 603 is configured to: simultaneously receive, by the edge user in a current subframe, coordinated scheduling of the serving node and the coordinating node, and calculate, according to a signal to interference plus noise ratio CQI_edge3 of the coordinated scheduling, a proportional fairness PF priority corresponding to the edge user served by the serving node and a PF priority corresponding to the edge user served by the coordinating node; and compare the PF priority corresponding to the edge user served by the serving node and the PF priority corresponding to the edge user served by the coordinating node with PF priorities corresponding to another user separately served by the serving node and the coordinating node. If the PF priority corresponding to the edge user served by the serving node is higher than a PF priority corresponding to the another user served by the serving node, the serving node can schedule the edge user; and if the PF priority corresponding to the edge user served by the coordinating node is higher than a PF priority corresponding to the another user served by the coordinating node, the coordinating node can schedule the edge user.

A notification unit 604, configured to: instruct the serving node and the coordinating node to allocate a same code channel resource to send data to the edge user in response to a determination that the serving node and the coordinating node can simultaneously schedule the edge user.

Optionally, the determining unit 603 is further configured to determine whether the serving node can schedule the edge user if the serving node and the coordinating node cannot simultaneously schedule the edge user. In response to a determination that the serving node can schedule the edge user, the serving node independently schedules the edge user. Determining whether the serving node can schedule the edge user includes: in a case in which the edge user receives independent scheduling of the serving node, calculating, according to a signal to interference plus noise ratio CQI_edge1 of the independent scheduling of the serving node, the PF priority corresponding to the edge user served by the serving node; and comparing the PF priority corresponding to the edge user served by the serving node with a PF priority corresponding to another user served by the serving node. If the PF priority corresponding to the edge user served by the serving node is higher than the PF priority corresponding to the another user served by the serving node, the serving node can independently schedule the edge user.

Optionally, the determining unit 603 is further configured to determine whether the coordinating node can schedule the edge user, if the serving node and the coordinating node cannot simultaneously schedule the edge user, and the serving node cannot schedule the edge user. In response to a determination that the coordinating node can schedule the edge user, the coordinating node independently schedules the edge user. Determining whether the coordinating node can schedule the edge user includes: in a case in which the edge user receives independent scheduling of the coordinating node, calculating, according to a signal to interference plus noise ratio CQI_edge2 of the independent scheduling of the coordinating node, the PF priority corresponding to the edge user served by the coordinating node; and comparing the PF priority corresponding to the edge user served by the coordinating node with a PF priority corresponding to another user served by the coordinating node. If the PF priority corresponding to the edge user served by the coordinating node is higher than the PF priority corresponding to the another user served by the coordinating node, the coordinating node can independently schedule the edge user.

Optionally, the device further includes: a processing unit, and the processing unit is configured to: if the serving node and the coordinating node cannot simultaneously schedule the edge user, the serving node cannot independently schedule the edge user, and the coordinating node cannot independently schedule the edge user, skip scheduling the edge user.

Optionally, the device further includes: a scheduling unit, and the scheduling unit is configured to: schedule a center user according to spatial reuse mode SRM, where the center user refers to a user with a difference between the first strength and the second strength of the reference signal power being greater than the preset threshold.

Specifically, a CCU first performs grouping according to sequence number information of the serving node and the coordinating node fed back by users. In this embodiment, there are five transmission nodes in a softcell, so that the users are divided into five groups, each transmission node is responsible for data transmission of the node used as a serving node, and the CCU independently performs PF scheduling on users of each group. A user group in which a BS is a serving node is used as an example below to describe a coordinated scheduling solution put forward in the present disclosure, and a process of scheduling a user served by another transmission node is the same. It is assumed that there are p center users and q edge users in the group, and a coordinating node set assisting in transmission of the edge users of the group is C. A CQI set fed back by the center users is {CQI_{c}}, a CQI set that is fed back by the edge user and that is independently served by the serving node is {CQI₁}, a CQI set that is fed back by the edge user and that is independently served by the coordinating node is {CQI₂}, and a CQI set fed back by the edge user when the serving node and the coordinating node perform coordinated transmission by means of beamforming is {CQI₃}.

In the present disclosure, information about a serving node and information about a coordinating node of an edge user are obtained, coordinated scheduling is performed on the edge user according to the information about the serving node and the information about the coordinating node, it is determined whether the serving node and the coordinating node can simultaneously schedule the edge user, and if yes, the serving node and the coordinating node are instructed to allocate a same code channel resource to send data to the edge user, so that the edge user is served in a coordinated transmission manner via beamforming based on code channel multiplexing, improving a received signal-to-noise ratio of the edge user.

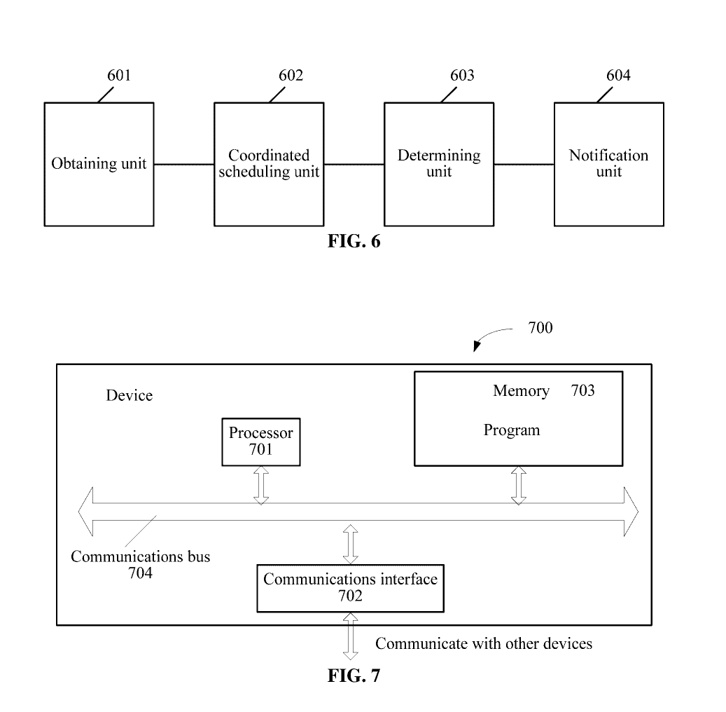

FIG. 7 is a structural diagram of another downlink scheduling device according to an embodiment. Referring to FIG. 7, FIG. 7 shows a device 700 provided in this embodiment, and a specific embodiment does not limit specific implementation of the device. The device 700 includes a processor 701, a communications interface 702, a memory 703, and a bus 704.

The processor 701, the communications interface 702, and the memory 703 communicate with each other by using the bus 704.

The communications interface 702 is configured to communicate with a routing processing server.

The processor 701 is configured to execute a program.

Specifically, the program may include program code, and the program code includes a computer operation instruction.

The processor 701 may be a Central Processing Unit (CPU) or an Application-Specific Integrated Circuit (ASIC), or is configured as one or more integrated circuits that implement the embodiment.

The memory 703 is configured to store the program. The memory 703 may be a volatile memory, such as a Random Access Memory (RAM), or a non-volatile memory, such as a Read-Only Memory (ROM), a flash memory, a Hard Disk Drive (HDD), or a Solid State Drive (SSD). The processor 701 performs the following method according to a program instruction stored in the memory 703. Obtaining information about a serving node and information about a coordinating node of an edge user, where the serving node refers to a node whose strength of reference signal power, received by the edge user from all nodes in a softcell in which the edge user is located, is first strength, the coordinating node refers to a node whose strength of reference signal power, received by the edge user from all the nodes in the softcell in which the edge user is located, is second strength, and the edge user refers to a user with a difference between the first strength and the second strength of the reference signal power being within a preset threshold. Performing coordinated scheduling on the edge user according to the information about the serving node and the information about the coordinating node. Determining whether the serving node and the coordinating node can simultaneously schedule the edge user. In response to a determination that the serving node and the coordinating node can simultaneously schedule the edge user, instructing the serving node and the coordinating node to allocate a same code channel resource to send data to the edge user.

The determining whether the serving node and the coordinating node can simultaneously schedule the edge user includes: simultaneously receiving, by the edge user in a current subframe, coordinated scheduling of the serving node and the coordinating node, and calculating, according to a signal to interference plus noise ratio CQI_edge3 of the coordinated scheduling, a proportional fairness PF priority corresponding to the edge user served by the serving node and a PF priority corresponding to the edge user served by the coordinating node; and comparing the PF priority corresponding to the edge user served by the serving node and the PF priority corresponding to the edge user served by the coordinating node with PF priorities corresponding to another user separately served by the serving node and the coordinating node. If the PF priority corresponding to the edge user served by the serving node is higher than a PF priority corresponding to the another user served by the serving node, the serving node can schedule the edge user; and if the PF priority corresponding to the edge user served by the coordinating node is higher than a PF priority corresponding to the another user served by the coordinating node, the coordinating node can schedule the edge user.

The method further includes: if the serving node and the coordinating node cannot simultaneously schedule the edge user, determining whether the serving node can schedule the edge user. In response to a determination that the serving node can schedule the edge use, the serving node independently schedules the edge user. Determining whether the serving node can schedule the edge user includes: in a case in which the edge user receives independent scheduling of the serving node, calculating, according to a signal to interference plus noise ratio CQI_edge1 of the independent scheduling of the serving node, the PF priority corresponding to the edge user served by the serving node; and comparing the PF priority corresponding to the edge user served by the serving node with a PF priority corresponding to another user served by the serving node. If the PF priority corresponding to the edge user served by the serving node is higher than the PF priority corresponding to the another user served by the serving node, the serving node can independently schedule the edge user.

The method further includes if the serving node and the coordinating node cannot simultaneously schedule the edge user, and the serving node cannot schedule the edge user, determining whether the coordinating node can schedule the edge user. In response to a determination that the coordinating node can schedule the edge user, the coordinating node independently schedules the edge user. Determining whether the coordinating node can schedule the edge user includes: in a case in which the edge user receives independent scheduling of the coordinating node, calculating, according to a signal to interference plus noise ratio CQI_edge2 of the independent scheduling of the coordinating node, the PF priority corresponding to the edge user served by the coordinating node; and comparing the PF priority corresponding to the edge user served by the coordinating node with a PF priority corresponding to another user served by the coordinating node. If the PF priority corresponding to the edge user served by the coordinating node is higher than the PF priority corresponding to the another user served by the coordinating node, the coordinating node can independently schedule the edge user.

The method further includes: receiving CQI information fed back by the edge user by using a differential feedback method, where the differential feedback manner is: feeding back CQI_edge1, a difference between CQI_edge2 and CQI_edge1, and a difference between CQI_edge3 and CQI_edge1, or presetting thresholds X and Y, if CQI_edge2 is higher than CQI_edge1 by X or more than X, feeding back X, and if CQI_edge3 is higher than CQI_edge1 by Y or more than Y, feeding back Y.

The method further includes: if the serving node and the coordinating node cannot simultaneously schedule the edge user, the serving node cannot independently schedule the edge user, and the coordinating node cannot independently schedule the edge user, skipping scheduling the edge user.

The method further includes: scheduling a center user according to spatial reuse mode SRM, where the center user refers to a user with a difference between the first strength and the second strength of the reference signal power being greater than the preset threshold.

The present disclosure provides a downlink scheduling method and device, where in the method, information about a serving node and information about a coordinating node of an edge user are obtained, coordinated scheduling is performed on the edge user according to the information about the serving node and the information about the coordinating node, it is determined whether the serving node and the coordinating node can simultaneously schedule the edge user, and if yes, the serving node and the coordinating node are instructed to allocate a same code channel resource to send data to the edge user, so that the edge user is served in a coordinated transmission manner via beamforming based on code channel multiplexing, improving a received signal-to-noise ratio of the edge user.

The foregoing descriptions are merely exemplary implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method, comprising:
obtaining information about a serving node and information about a coordinating node of an edge user, wherein the serving node refers to a node whose strength of reference signal power, received by the edge user from all nodes in a softcell in which the edge user is located, is first strength, the coordinating node refers to a node whose strength of reference signal power, received by the edge user from all the nodes in the softcell in which the edge user is located, is second strength, and the edge user refers to a user with a difference between the first strength and the second strength of the reference signal power being within a preset threshold;
scheduling the edge user according to the information about the serving node and the information about the coordinating node; and
determining whether the serving node and the coordinating node can simultaneously schedule the edge user.

2. The method according to claim 1, wherein the serving node and the coordinating node can simultaneously schedule the edge user, and wherein the method further comprises instructing the serving node and the coordinating node to allocate a same code channel resource to send data to the edge user.

3. The method according to claim 1, wherein determining whether the serving node and the coordinating node can simultaneously schedule the edge user comprises:
simultaneously receiving, by the edge user in a current subframe, coordinated scheduling of the serving node and the coordinating node, and calculating, according to a signal to interference plus noise ratio CQI_edge3 of the coordinated scheduling, a proportional fairness (PF) priority corresponding to the edge user served by the serving node and a PF priority corresponding to the edge user served by the coordinating node; and
comparing the PF priority corresponding to the edge user served by the serving node and the PF priority corresponding to the edge user served by the coordinating node with PF priorities corresponding to another user separately served by the serving node and the coordinating node, wherein
in response to the PF priority corresponding to the edge user served by the serving node being higher than a PF priority corresponding to the another user served by the serving node, the serving node can schedule the edge user; and
in response to the PF priority corresponding to the edge user served by the coordinating node being higher than a PF priority corresponding to the another user served by the coordinating node, the coordinating node can schedule the edge user.

4. The method according to claim 1, the serving node and the coordinating node cannot simultaneously schedule the edge user, and wherein the method further comprises:
determining whether the serving node can schedule the edge user, wherein:
the serving node independently schedules the edge user in response to a determination that the serving node can schedule the edge user; and
the determining whether the serving node can schedule the edge user comprises:
calculating, according to a signal to interference plus noise ratio CQI_edge1 of the independent scheduling of the serving node, a PF priority corresponding to the edge user served by the serving node when the edge user receives independent scheduling of the serving node; and
comparing the PF priority corresponding to the edge user served by the serving node with a PF priority corresponding to another user served by the serving node, wherein
in response to the PF priority corresponding to the edge user served by the serving node being higher than the PF priority corresponding to the another user served by the serving node, the serving node can independently schedule the edge user.

5. The method according to claim 4, further comprising:
determining whether the coordinating node can schedule the edge user when the serving node and the coordinating node cannot simultaneously schedule the edge user, and the serving node cannot schedule the edge user, wherein:
the coordinating node independently schedules the edge user in response to a determination that the coordinating node can schedule the edge user; and
the determining whether the coordinating node can schedule the edge user comprises:
calculating, according to a signal to interference plus noise ratio CQI_edge2 of the independent scheduling of the coordinating node, a PF priority corresponding to the edge user served by the coordinating node when the edge user receives independent scheduling of the coordinating node; and
comparing the PF priority corresponding to the edge user served by the coordinating node with a PF priority corresponding to another user served by the coordinating node, wherein, in response to the PF priority corresponding to the edge user served by the coordinating node being higher than the PF priority corresponding to the another user served by the coordinating node, the coordinating node can independently schedule the edge user.

6. The method according to claim 5, further comprising:
receiving CQI information fed back by the edge user by using a differential feedback method, wherein
the differential feedback method comprises:
feeding back CQI_edge1, a difference between CQI_edge2 and CQI_edge1, and a difference between CQI_edge3 and CQI_edge1, or presetting thresholds X and Y, if CQI_edge2 is higher than CQI_edge1 by X or more than X, feeding back X; and
in response to CQI_edge3 being higher than CQI_edge1 by Y or more than Y, feeding back Y.

7. The method according to claim 1, further comprising:
skipping scheduling the edge user when the serving node and the coordinating node cannot simultaneously schedule the edge user, the serving node cannot independently schedule the edge user, and the coordinating node cannot independently schedule the edge user.

8. The method according to claim 1, further comprising:
scheduling a center user according to spatial reuse mode (SRM), wherein the center user refers to a user with a difference between the first strength and the second strength of the reference signal power being greater than the preset threshold.

9. A device, comprising:
an obtaining unit, configured to obtain information about a serving node and information about a coordinating node of an edge user, wherein the serving node refers to a node whose strength of reference signal power, received by the edge user from all nodes in a softcell in which the edge user is located, is first strength, the coordinating node refers to a node whose strength of reference signal power, received by the edge user from all the nodes in the softcell in which the edge user is located, is second strength, and the edge user refers to a user with a difference between the first strength and the second strength of the reference signal power being within a preset threshold;
a coordinated scheduling unit, configured to perform coordinated scheduling on the edge user according to the information about the serving node and the information about the coordinating node; and
a determining unit, configured to determine whether the serving node and the coordinating node can simultaneously schedule the edge user.

10. The device according to claim 9, further comprising a notification unit, configured to instruct the serving node and the coordinating node to allocate a same code channel resource to send data to the edge user in response to a determination that the serving node and the coordinating node can simultaneously schedule the edge user.

11. The device according to claim 9, wherein the determining unit is configured to:
simultaneously receive, by the edge user in a current subframe, coordinated scheduling of the serving node and the coordinating node, and calculate, according to a signal to interference plus noise ratio CQI_edge3 of the coordinated scheduling, a proportional fairness (PF) priority corresponding to the edge user served by the serving node and a PF priority corresponding to the edge user served by the coordinating node; and
compare the PF priority corresponding to the edge user served by the serving node and the PF priority corresponding to the edge user served by the coordinating node with PF priorities corresponding to another user separately served by the serving node and the coordinating node, wherein
in response to the PF priority corresponding to the edge user served by the serving node being higher than a PF priority corresponding to the another user served by the serving node, the serving node can schedule the edge user; and
in response to the PF priority corresponding to the edge user served by the coordinating node being higher than a PF priority corresponding to the another user served by the coordinating node, the coordinating node can schedule the edge user.

12. The device according to claim 9, wherein the determining unit is further configured to:
determine whether the serving node can schedule the edge user when the serving node and the coordinating node cannot simultaneously schedule the edge user, wherein the serving node independently schedules the edge user in response to a determination that the serving node can schedule the edge user.

13. The device according to claim 12, wherein determining whether the serving node can schedule the edge user comprises:
when the edge user receives independent scheduling of the serving node, calculating, according to a signal to interference plus noise ratio CQI_edge1 of the independent scheduling of the serving node, a PF priority corresponding to the edge user served by the serving node; and
comparing the PF priority corresponding to the edge user served by the serving node with a PF priority corresponding to another user served by the serving node, wherein
in response to the PF priority corresponding to the edge user served by the serving node being higher than the PF priority corresponding to the another user served by the serving node, the serving node can independently schedule the edge user.

14. The device according to claim 12, wherein the determining unit is further configured to:
determine whether the coordinating node can schedule the edge user when serving node and the coordinating node cannot simultaneously schedule the edge user, and the serving node cannot schedule the edge user, wherein the coordinating node independently schedules the edge user in response to a determination that the coordinating node can schedule the edge user.

15. The device according to claim 14, wherein determining whether the coordinating node can schedule the edge user comprises:
calculating, according to a signal to interference plus noise ratio CQI_edge2 of the independent scheduling of the coordinating node, a PF priority corresponding to the edge user served by the coordinating node when the edge user receives independent scheduling of the coordinating node; and
comparing the PF priority corresponding to the edge user served by the coordinating node with a PF priority corresponding to another user served by the coordinating node, wherein in response to the PF priority corresponding to the edge user served by the coordinating node being higher than the PF priority corresponding to the another user served by the coordinating node, the coordinating node can independently schedule the edge user.

16. The device according to claim 14, further comprising a receiving unit configured to:
receive CQI information fed back by the edge user by using a differential feedback method, wherein
the differential feedback method comprises feeding back CQI_edge1, a difference between CQI_edge2 and CQI_edge1, and a difference between CQI_edge3 and CQI_edge1, or presetting thresholds X and Y, if CQI_edge2 is higher than CQI_edge1 by X or more than X, feeding back X, and feeding back Y when CQI_edge3 is higher than CQI_edge1 by Y or more than Y.

17. The device according to claim 9, further comprising a processing unit configured to:
skip scheduling the edge user when the serving node and the coordinating node cannot simultaneously schedule the edge user, the serving node cannot independently schedule the edge user, and the coordinating node cannot independently schedule the edge user.

18. The device according to claim 9, further comprising a scheduling unit configured to:
schedule a center user according to spatial reuse mode (SRM), wherein the center user refers to a user with a difference between the first strength and the second strength of the reference signal power being greater than the preset threshold.
